(19) United States
(12) Patent Application Publication
(10) Pub. No.: US 2025/0324229 A1
(43) Pub. Date: Oct. 16, 2025

(54) AN APPARATUS AND A METHOD FOR PASSIVE TERMINAL DISCOVERY

(71) Applicant: Nokia Technologies Oy, Espoo (FI)

(72) Inventors: Oana-Elena BARBU, Aalborg (DK); Benny VEJLGAARD, Gistrup (DK)

(73) Assignee: Nokia Technologies Oy, Espoo (FI)

(21) Appl. No.: 18/861,985

(22) PCT Filed: May 9, 2022
(86) PCT No.: PCT/EP2022/062423

§ 371 Date: Oct. 31, 2024

(51) Int. Cl. H04W 8/00; H04W 24/10

(52) U.S. Cl. CPC H04W 8/005; H04W 24/10

(57) ABSTRACT

There is provided an apparatus comprising at least one processor; and at least one memory including computer program code, the at least one memory and the computer program code configured to, with the at least one processor, cause the apparatus to perform at least: receiving, from a network node, configuration of at least one passive terminal discovery signal associated with at least one passive radio; transmitting at least one passive terminal discovery signal according to the configuration; and/or receiving at least one passive terminal discovery signal according to the configuration; measuring at least one backscatter passive terminal discovery signal from the at least one passive radio; and reporting at least the measured backscatter to the network node.

### FIELD

Various example embodiments relate to passive terminal discovery.

### BACKGROUND

The number of internet of things (IoT) connections has been growing rapidly in recent years. There is a need for IoT devices with low cost and power consumption.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a first aspect, there is provided an apparatus comprising at least one processor; and at least one memory including computer program code, the at least one memory and the computer program code configured to, with the at least one processor, cause the apparatus to perform at least: receiving, from a network node, configuration of at least one passive terminal discovery signal associated with at least one passive radio; transmitting at least one passive terminal discovery signal according to the configuration; and/or receiving at least one passive terminal discovery signal according to the configuration; measuring at least one backscatter passive terminal discovery signal from the at least one passive radio; and reporting at least the measured backscatter to the network node.

According to a second aspect, there is provided an apparatus comprising at least one processor; and at least one memory including computer program code, the at least one memory and the computer program code configured to, with the at least one processor, cause the apparatus to perform at least: transmitting, to at least one active radio, configuration of at least one passive terminal discovery signal associated with at least one passive radio; triggering reception and/or transmission of the at least one passive terminal discovery signal; receiving, from the at least one active radio, at least measured backscatter of at least one backscatter passive terminal discovery signal from at least one passive radio the at least one active radio has detected; and determining, based on the received measured backscatter from the at least one active radio, whether to associate the at least one active radio with the at least one detected passive radio.

According to a third aspect, there is provided a method, comprising: receiving, by an active radio from a network node, configuration of at least one passive terminal discovery signal associated with at least one passive radio; transmitting at least one passive terminal discovery signal according to the configuration; and/or receiving at least one passive terminal discovery signal according to the configuration; measuring at least one backscatter passive terminal discovery signal from the at least one passive radio; and reporting at least the measured backscatter to the network node.

According to a fourth aspect, there is provided a method, comprising: transmitting, by a network node to at least one active radio, configuration of at least one passive terminal discovery signal associated with at least one passive radio; triggering reception and/or transmission of the at least one passive terminal discovery signal; receiving, from the at least one active radio, at least measured backscatter of at least one backscatter passive terminal discovery signal from at least one passive radio the at least one active radio has detected; and determining, based on the received measured backscatter from the at least one active radio, whether to associate the at least one active radio with the at least one detected passive radio.

According to a fifth aspect, there is provided an apparatus, comprising means for performing: receiving, from a network node, configuration of at least one passive terminal discovery signal associated with at least one passive radio; transmitting at least one passive terminal discovery signal according to the configuration; and/or receiving at least one passive terminal discovery signal according to the configuration; measuring at least one backscatter passive terminal discovery signal from the at least one passive radio; and reporting at least the measured backscatter to the network node.

According to a sixth aspect, there is provided an apparatus, comprising means for performing: transmitting, to at least one active radio, configuration of at least one passive terminal discovery signal associated with at least one passive radio; triggering reception and/or transmission of the at least one passive terminal discovery signal; receiving, from the at least one active radio, at least measured backscatter of at least one backscatter passive terminal discovery signal from at least one passive radio the at least one active radio has detected; and determining, based on the received measured backscatter from the at least one active radio, whether to associate the at least one active radio with the at least one detected passive radio.

According to a seventh aspects, there is provided a computer readable medium comprising program instructions that, when executed by at least one processor, cause an apparatus to at least perform: receiving, from a network node, configuration of at least one passive terminal discovery signal associated with at least one passive radio; transmitting at least one passive terminal discovery signal according to the configuration; and/or receiving at least one passive terminal discovery signal according to the configuration; measuring at least one backscatter passive terminal discovery signal from the at least one passive radio; and reporting at least the measured backscatter to the network node.

According to an eighth aspect, there is provided a computer readable medium comprising program instructions that, when executed by at least one processor, cause an apparatus to at least perform: transmitting, to at least one active radio, configuration of at least one passive terminal discovery signal associated with at least one passive radio; triggering reception and/or transmission of the at least one passive terminal discovery signal; receiving, from the at least one active radio, at least measured backscatter of at least one backscatter passive terminal discovery signal from at least one passive radio the at least one active radio has detected; and determining, based on the received measured backscatter from the at least one active radio, whether to associate the at least one active radio with the at least one detected passive radio.

According to a ninth aspect, there is provided a computer program configured to cause an apparatus, when run on the apparatus, to perform a method comprising: receiving, from a network node, configuration of at least one passive terminal discovery signal associated with at least one passive radio; transmitting at least one passive terminal discovery signal according to the configuration; and/or receiving at least one passive terminal discovery signal according to the configuration; measuring at least one backscatter passive terminal discovery signal from the at least one passive radio; and reporting at least the measured backscatter to the network node.

According to a tenth aspect, there is provided a computer program configured to cause an apparatus, when run on the apparatus, to perform a method comprising: transmitting, to at least one active radio, configuration of at least one passive terminal discovery signal associated with at least one passive radio; triggering reception and/or transmission of the at least one passive terminal discovery signal; receiving, from the at least one active radio, at least measured backscatter of at least one backscatter passive terminal discovery signal from at least one passive radio the at least one active radio has detected; and determining, based on the received measured backscatter from the at least one active radio, whether to associate the at least one active radio with the at least one detected passive radio.

According to an eleventh aspect, there is provided an apparatus comprising: an energy harvester; at least one processor; and at least one memory including computer program code, the at least one memory and the computer program code configured to, with the at least one processor, cause the apparatus to perform at least: receiving at least one passive terminal discovery signal; harvesting, using the energy harvester, energy at least from the received passive terminal discovery signal; generating, at least based on the harvested energy, at least one backscatter passive terminal discovery signal, if the received passive terminal discovery signal comprises a sub-signature associated with the apparatus; and refraining from generating the at least one backscatter passive terminal discovery signal if the received passive terminal discovery signal does not comprise the sub-signature associated with the apparatus; and if generated, transmitting the at least one backscatter passive terminal discovery signal.

According to a twelfth aspect, there is provided a method, comprising: receiving, by a passive radio, at least one passive terminal discovery signal; harvesting, using an energy harvester, energy at least from the received passive terminal discovery signal; generating, at least based on the harvested energy, at least one backscatter passive terminal discovery signal, if the received passive terminal discovery signal comprises a sub-signature associated with the apparatus; and refraining from generating the at least one backscatter passive terminal discovery signal if the received passive terminal discovery signal does not comprise the sub-signature associated with the apparatus; and if generated, transmitting the at least one backscatter passive terminal discovery signal.

According to a thirteenth aspect, there is provided an apparatus, comprising means for: receiving at least one passive terminal discovery signal; harvesting, using an energy harvester, energy at least from the received passive terminal discovery signal; generating, at least based on the harvested energy, at least one backscatter passive terminal discovery signal, if the received passive terminal discovery signal comprises a sub-signature associated with the apparatus; and refraining from generating the at least one backscatter passive terminal discovery signal if the received passive terminal discovery signal does not comprise the sub-signature associated with the apparatus; and if generated, transmitting the at least one backscatter passive terminal discovery signal.

According to a fourteenth aspect, there is provided a computer program configured to cause an apparatus, when run on the apparatus, to perform the method of the thirteenth aspect.

According to a fifteenth aspect, there is provided a computer program configured to cause an apparatus, when run on the apparatus, to perform the method of the thirteenth aspect.

### BRIEF DESCRIPTION OF THE DRAWINGS

FIG. 1 shows, by way of example, backscatter communication;

FIG. 2 shows, by way of example, a passive terminal discovery signal;

FIG. 3 shows, by way of example, signalling between entities;

FIG. 4 shows, by way of example, signalling between entities;

FIG. 5 shows, by way of example, signalling between entities;

FIG. 6 shows, by way of example, signalling between entities;

FIG. 7 shows, by way of example, a flowchart of a method;

FIG. 8 shows, by way of example, a flowchart of a method;

FIG. 9 shows, by way of example, a block diagram of an apparatus; and

FIG. 10 shows, by way of example, a flowchart of a method.

### DETAILED DESCRIPTION

Devices with reduced capabilities have been suggested for satisfying the requirements on low cost and low power devices for wide area IoT communication. IoT devices communicating via new radio (NR) communication technologies, for example, via narrow band (NB) IoT module, consume even hundreds of milliwatts power for transmitting and receiving.

To achieve even lower cost and power consumption, batteryless devices may be used in IoT technology. Batteryless IoT devices are beneficial in a sense that there is no need to replace batteries of the IoT devices. An example of a batteryless device is a passive radio frequency identification (RFID) tag. The power consumption of commercial passive RFID tags can be as low as approximately 1 microwatt. Techniques enabling such low power consumption are envelope detection for downlink data reception, and backscatter communication for uplink data transmission. RFID technology is designed for short-range communications, whose typical effective range is less than 10 meters.

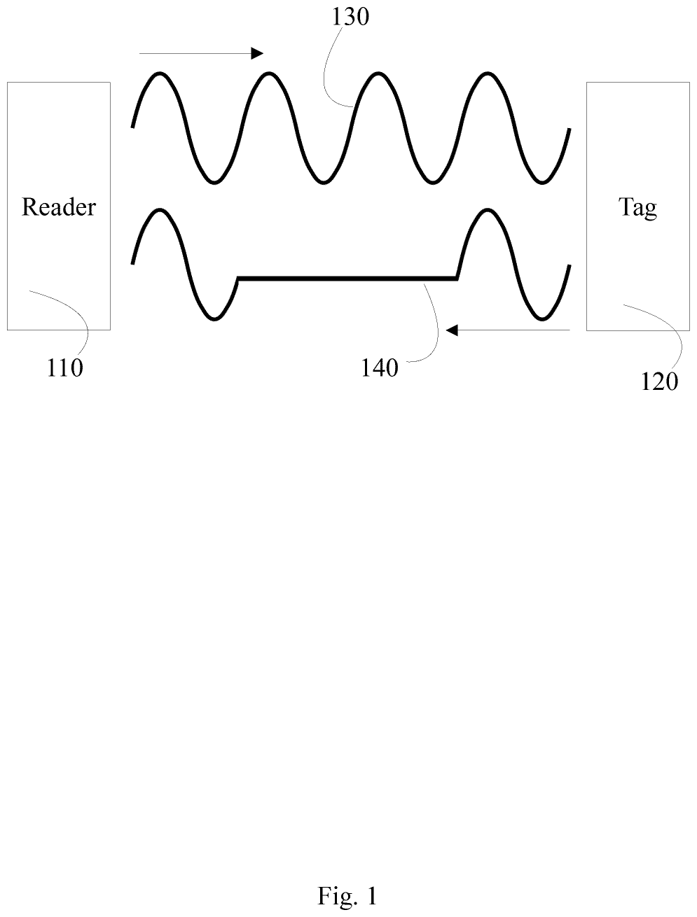

FIG. 1 shows, by way of example, backscatter communication. In backscatter communication, the backscatter transmitter 120, e.g. RFID tag, reflects the carrier wave 130 sent by a reader 110 after modifying one or more characteristics of the received signal to embed information into the signal. The information embedded into the signal may be tag-specific information, such as the identity of the tag, or any data the tag may collect. A backscatter signal 140 is a signal generated by the tag in response to hearing an activation signal. The characteristics of the signal may comprise, e.g., amplitude, phase, or center frequency. By modifying the signal, the tag 120 may implement data transmission without generating a carrier wave by itself. Communication via reflection instead of active radiation reduces the radio frequency (RF) frontend of the tag to a single transistor switch, which minimizes manufacturing costs as well as energy demands.

The tag may be configured to encode the signal to be reflected with a unique identity (ID) to achieve a unique signal. Then, a device, which may perform a determination based on information on an original signal transmitted by the reader and based on information on the reflected signals, knows which signal is the original signal and which signal is the reflected signal. For example, the device may be a positioning device, and the determination may be positioning of the tags.

The tag 120 may be a passive radio or passive device or passive terminal, e.g. a passive IoT device. Passive IoT devices refer to the IoT devices without power sources. Passive IoT devices or terminals may capture and collect energy by energy harvesting, for example, by collecting radio waves emitted from the network side. For example, passive radio may be associated with a passive terminal. That is, a passive terminal may comprise a passive radio. In at least some embodiments, the passive device may be a semi-passive device, e.g. a semi-passive tag. A semi-passive tag may use a battery to run the circuitry, but use harvested energy for communication.

The reader 110 may be an active device or an active radio or an active radio device. An active device refers to a device with a power source. For example, the active device may be a user equipment such as a mobile phone. The active device is configured to communicate with the network, e.g. with a network node, such as gNB. The active device may be, for example, a user equipment, e.g. NR UE, a road side unit (RSU), a small cell network node, e.g. gNB, etc.

The passive device or a plurality of passive devices may communicate directly to the network, e.g. NR network. Alternatively, the passive device or a plurality of passive devices may communicate indirectly to the network, e.g. via one or more active devices, such as NR UEs.

Radio access architecture based on long term evolution advanced (LTE Advanced, LTE-A) or new radio (NR), also known as fifth generation (5G), is used as an example of an access architecture. It is obvious for a person skilled in the art that the embodiments may also be applied to other kinds of communications networks having suitable means by adjusting parameters and procedures appropriately, such as 6G or WiFi.

The active device is configured to be in a wireless connection on one or more communication channels in a cell with an access node, such as gNB, i.e. next generation NodeB, or eNB, i.e. evolved NodeB (eNodeB), providing the cell. The physical link from a user device to the network node is called uplink (UL) or reverse link and the physical link from the network node to the user device is called downlink (DL) or forward link. It should be appreciated that network nodes or their functionalities may be implemented by using any node, host, server or access point etc. entity suitable for such a usage. A communications system typically comprises more than one network node in which case the network nodes may also be configured to communicate with one another over links, wired or wireless, designed for the purpose. These links may be used for signalling purposes. The network node is a computing device configured to control the radio resources of the communication system it is coupled to. The network node may also be referred to as a base station (BS), an access point or any other type of interfacing device including a relay station capable of operating in a wireless environment. The network node includes or is coupled to transceivers. From the transceivers of the network node, a connection is provided to an antenna unit that establishes bi-directional radio links to user devices. The antenna unit may comprise a plurality of antennas or antenna elements. The network node is further connected to core network (CN or next generation core NGC).

The user device, or user equipment UE, typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. A user device may also be a device having capability to operate in Internet of Things (IoT) network which is a scenario in which objects are provided with the ability to transfer data over a network without requiring human-to-human or human-to-computer interaction.

5G enables using multiple input-multiple output (MIMO) technology at both UE and gNB side, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 7 GHz, cmWave and mmWave, and also being integratable with existing legacy radio access technologies, such as the LTE. Below 7 GHz frequency range may be called as FR1, and above 24 GHz (or more exactly 24-52.6 GHz) as FR2, respectively. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 7 GHz-cmWave, below 7 GHz-cmWave-mmWave).

Methods are provided to enable data transfer from the passive IoT devices to a network node, which may be located very far away from the passive IoT devices. For example, passive IoT devices may operate in 5G NR infrastructure with licensed bands and over long ranges. Methods as disclosed herein enable a positioning framework that enables a passive IoT device or passive IoT devices to communicate and be positioned using a radio access network infrastructure, such as the 5G NR infrastructure.

An active device is configured to perform typical network functions, eg. NR functions, and additionally discover one or more passive devices, such as one or more passive terminals or passive IoT devices. The active device may continue its ongoing operations, but a network node is configured to modify behaviour of the active device to additionally perform passive terminal discovery (PTD). The active device is configured to act as a point of contact between the passive device and the network node, or NR backhaul. The signalling between the passive device and the active device, and the signalling between the active device and the network node enable the network node to associate one or more active devices with one or more passive devices and populate an IoT infrastructure. The methods as disclosed herein enable the network node to collect data from the passive devices and/or locate the passive devices.

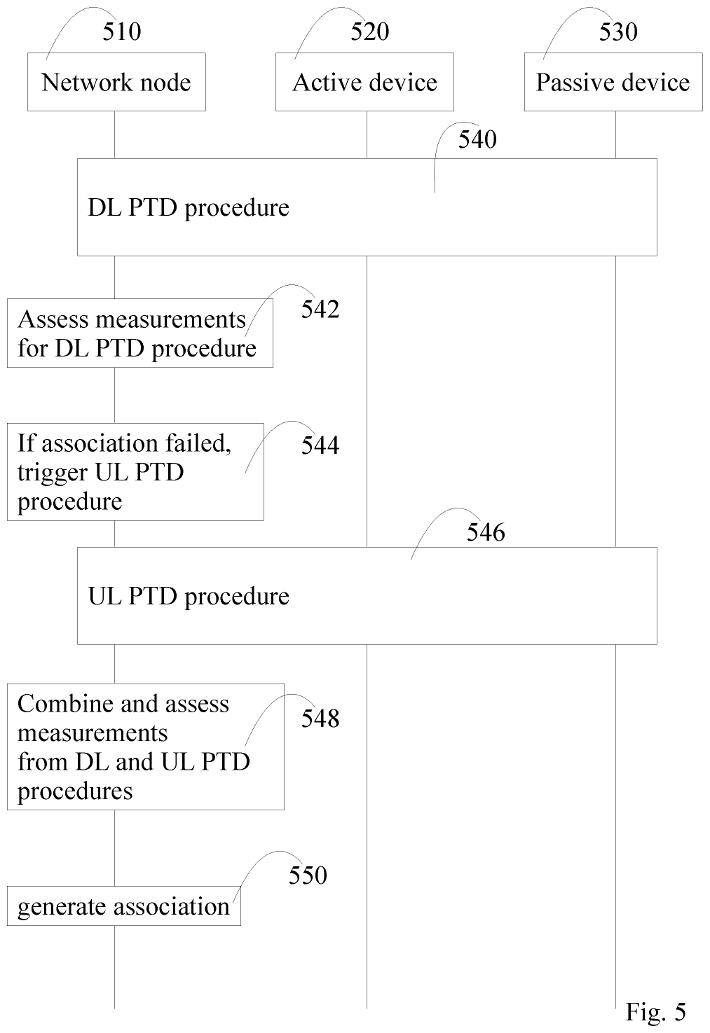

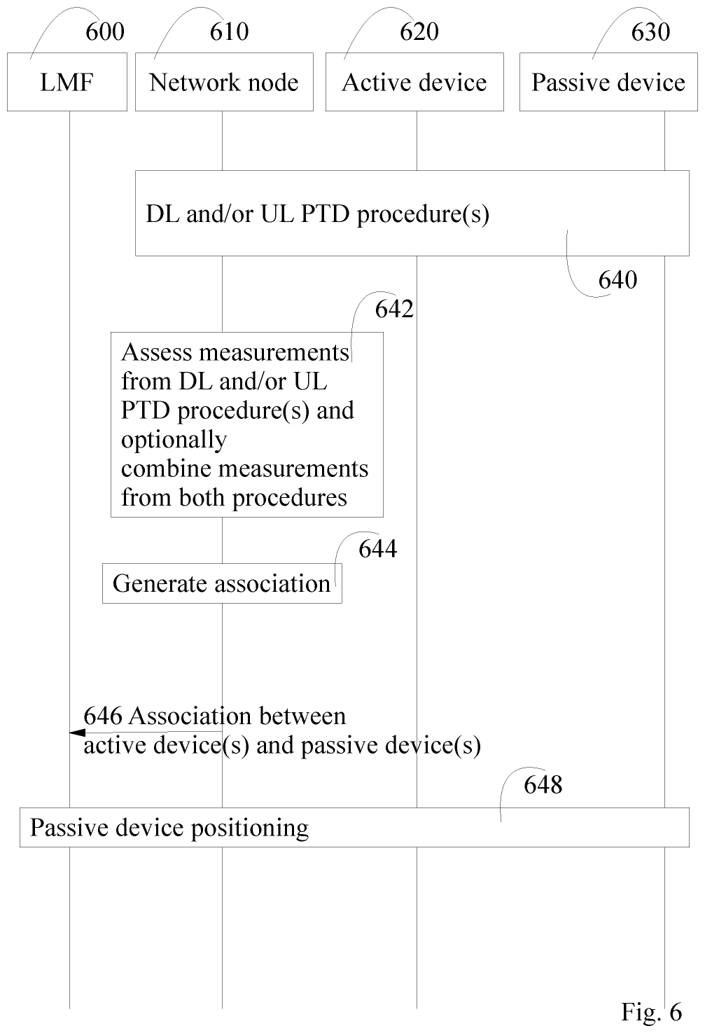

PTD may be performed as a downlink (DL) PTD procedure or an uplink (UL) PTD procedure, which may be activated autonomously, i.e. one or the other, or sequentially, i.e. one after the other, if unsatisfactory results are obtained using the first used procedure, for example. If both procedures have been used, the measurements of both procedures may be combined, as described in the context of FIG. 5 and FIG. 6.

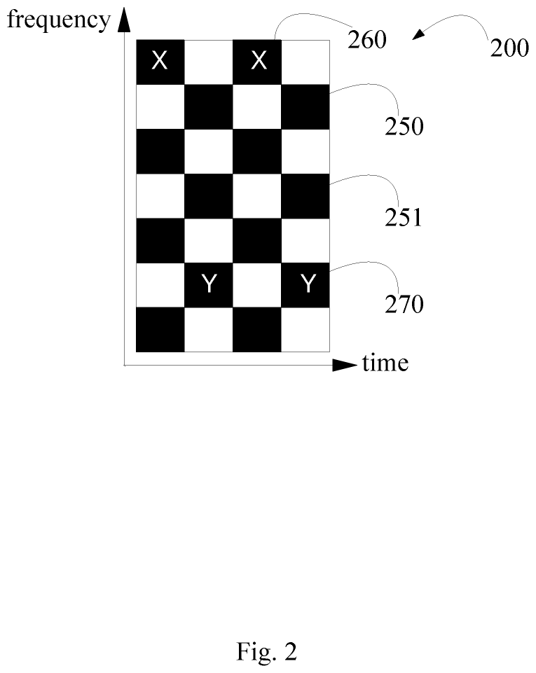

FIG. 2 shows, by way of example, a passive terminal discovery (PDT) signal 200. The PDT signal, or a PDT reference signal (RS), comprises a signature encoded to the signal. The black squares, e.g. squares 250, 251, represent the signature, which is specific to the active device. For example, the signature of the PDT RS may be NR UE specific. The signature may be defined, for example, as a complete parameter set needed to generate the signal. The parameters may comprise, for example, time, frequency, code or modulation, and repetition pattern.

For example, a unique DL RS configuration, or a DL RS signature may be given by one or more of the following parameters:
Time dimension: for example, subframe-index, symbol-index-in-the-subframe
Frequency dimension: for example, carrier frequency, subcarrier-start-index, subcarrier-stop-index, comb-pattern
Waveform: for example, a) OFDM with QPSK modulation; or b) Zadoff-Chu sequence with length Nzc, and root u
Repetition pattern: for example, G subframes.

The PDT signal further comprises a sub-signature, which may be associated with a passive device and/or with a group of passive devices. The sub-signature may be a passive device specific configuration of a subset of radio resources used to activate the specific passive device. The passive device might not activate if the PDT signal does not comprise passive device specific and/or group (i.e. group to which said passive device belongs) specific sub-signature. If the PDT signal comprises passive device specific and/or group specific sub-signature, it may activate as described herein. When activated, the passive device is triggered to collect energy and generate a backscatter signal as a response. The radio resources may comprise, for example, time-frequency-code resources. Thus, the identity (ID) of the passive device may be retrieved from the sub-signature of the signal. The sub-signature is encoded into the signal. The sub-signature may be defined as a subset of the complete parameter set used to generate the original signal. In the example of FIG. 2, the sub-signature X 260 refers to a sub-signature associated with passive device X, and the sub-signature Y 270 refers to a sub-signature associated with passive device Y.

For example, a sub-signature encoded to the signal and corresponding to a passive terminal with identity X (idX) may comprise one or more of the following parameters:
Time dimension: for example, subframe-index, symbol-idXindex-in-the-subframe
Frequency dimension: for example, carrier frequency, subcarrier-start-idXindex, subcarrier-stop-idXindex, comb-pattern-idX
Waveform: for example, a) Zadoff-Chu sequence with length N≠Nzc and root v≠u so that there is a unique mapping between the identity X and the set (N, u, time, frequency dimension); or b) Other amplitude and/or phase modulations. For example, a tag identified by identity X=10011110 may be activated by an on-off-keying (OOK) signal implementing the pattern X.

The PDT signal may be a DL PTD signal transmitted from the network node to the active device and one or more passive devices. The DL PTD signal may be a repurposed or redefined signal, such as a paging signal, a synchronization signal, a physical random access channel (PRACH) signal, sidelink (SL) demodulation reference signal (DMRS), or a DL positioning reference signal (PRS), etc. The association between the sub-signature and the ID of the passive device is known at the active device side. For example, the association may be signalled, e.g. explicitly signalled, from the serving network node to the active device.

The PDT signal may be an UL PTD signal transmitted from the active device to the network node and one or more passive devices. As with DL PTD signal, the UL PTD signal may be, for example, any active device specific signal or reference signal, which has been redefined. For example, the UL PTD signal may be a sounding reference signal (SRS), SRS for positioning, UL DMRS, etc.

For example, let us consider a standard single-purpose DL PTD RS occupying resources physical resource block 1 and physical resource block 2, that is, {PRB1, PRB2} with quadrature phase shift keying (QPSK) symbols used for estimating channel state information (CSI). The serving network node, e.g. gNB, may be configured to modify this signal so that it fulfils a double-purpose: PRB1 carries QPSK symbols and PRB2 carriers OOK signal X. OOK implementing the pattern X is the sub-signature associated with the passive device X.

Then, while PRB2 signal uniquely activates a passive device, e.g. a tag, with identity X, PRB1 and PRB2 may still be used to retrieve CSI. Thus, the PTD signal serves a double purpose of transmitting the CSI and signalling the identity of the passive device.

The passive device identity may be associated with more than one DL PTD RS, and in this way, the serving network node, e.g. gNB, may simultaneously activate several active devices, e.g. UEs, to detect the passive device with identity X.

The passive device may have a group ID and a unique ID. Then, an activator (active device or network node) which generates an activation signal, or PTD signal, with a signature embedding the group ID will activate all passive devices in the group, that is, having the same group ID.

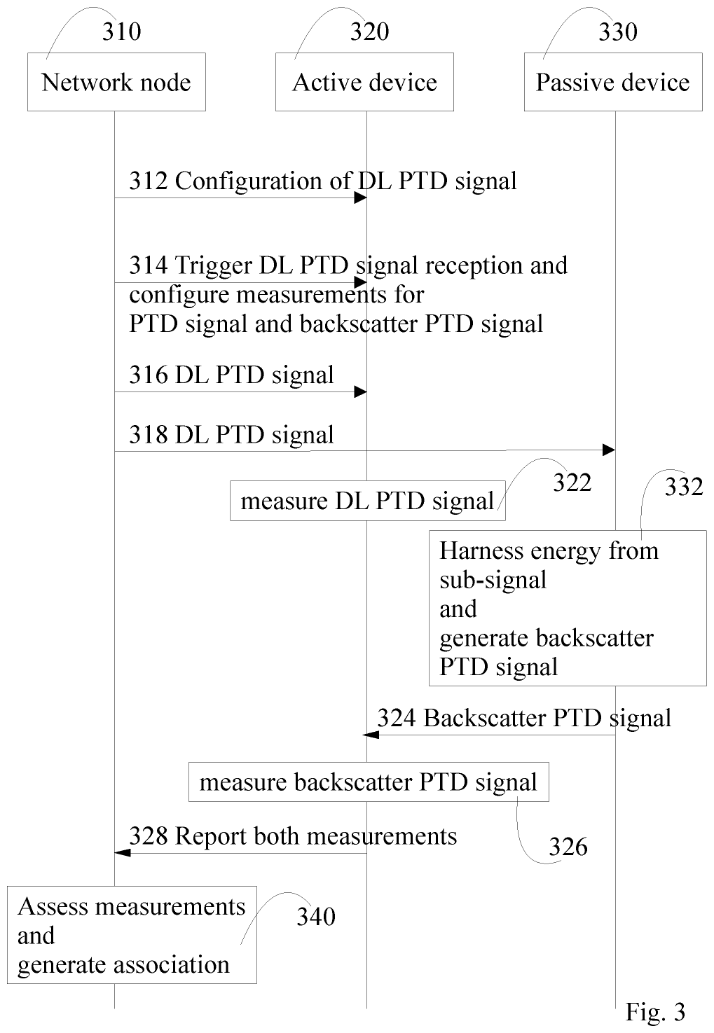

FIG. 3 shows, by way of example, signalling between entities. In this example, the DL PTD procedure is described. The network node 310, e.g. the serving gNB, transmits 312 a configuration of at least one PTD signal, e.g. PTD RS, associated with at least one passive device 330. The configuration provides the configuration of the PTD signal and implicitly the IDs of the passive devices. For example, the configuration may be specific to a pair of active device and a passive device.

The active device 320 receives, implicitly or explicitly, information for determining association between the at least one passive device and the at least one backscatter PTD signal. The association may be defined by a sub-signature associated with the at least one passive device, as described in the context of FIG. 2.

The network node 310 triggers 314 DL PTD signal reception by a selected active device 320, e.g. UE, or a set of active devices randomly distributed in the cell, and configures measurements for the DL PTD signal 316 and backscatter PTD signal 324 to be reflected by the at least one passive device 330. The selection of the active device may be based on, for example, random selection or past location of the passive device. The configuration provides a configuration of the subsequent reception of the DL PTD signal 316. For example, the configuration comprises a duration T of detection, measurement types, etc. In other words, the network node 310 requests the active device 320 to listen for a time period T for a DL PTD signal 316 and a backscatter PTD signal 324.

The network node 310 transmits DL PTD signals 316, 318 to at least one active device 320 and at least one passive device 330.

The DL PTD signal 316 is used by the active device for its own standard functions, such as to synchronize to the cell, to acquire channel state information (CSI), etc. The active device 320 receives and measures 322 the at least one PTD signal according to the configuration.

The passive device 330 comprises an energy harvester. Thus, the passive device is capable of harvesting or harnessing energy from various sources, such as radio waves or signals, vibration and/or light. The passive device 330 harnesses 332 energy from the received PTD signal 318, or sub-signal, and generates a backscatter PTD signal. The backscatter PTD signal 324 is obtained by modifying, by the passive device 330, the received PTD signal and reflecting, by the passive device 330, the modified signal to be detected by the active device 320. The PDT signal may be modified by altering its amplitude, phase and/or center frequency, for example.

By knowing the sub-signature corresponding to the ID of the passive device 330, the active device 320 knows the backscatter PTD signature. Therefore, the active device 320 is able to detect the backscatter PTD signal 324 without any additional signalling cost.

During the time period T, the active device 320 listens and detects and measures 322 the DL PTD signal 316 from the network node 310 and detects and measures 326 the backscatter PTD signal 324 from the passive device 330. The measurements of the PTD signal may comprise, for example, received signal strength indicator (RSSI), reference signal received power (RSRP), or any link quality metric.

The active device 320 reports 328 at least the measured backscatter to the network node 310. In at least some embodiments, the active device 320 reports both measurements to the network node 310. The measurements associated with the PTD signal 316 may relate to the ongoing functions of the active device. The measurements associated with the backscatter PTD signal 324 may relate to the passive IoT framework for assisting the network node to collect data from the passive devices and locate the passive devices.

The report 328 may comprise, for example, a PTD flag and the results of the measurements associated with the identities of the detected passive devices.

The network node 310 assesses 340 the reported measurements, and may determine, based on the measurements, whether to associate the at least one active device 320 with the at least one detected passive device 330. For example, the network node may receive measurement reports from multiple active devices. The network node may be configured to compare the measurements, and select the active device, which reported the highest signal quality, for example, the highest received (RX) power. In other words, the active device, which has reported measurement results indicating that the active device hears the passive device the loudest, may be paired or associated with the passive device. If the network node receives measurement report from one active device, the network node may determine whether the reported measurement results satisfy some pre-determined threshold. If the measurement results do satisfy the threshold, the network node may generate association between the active device and the passive device. For example, if the RX power reported by the active device is higher than a pre-determined threshold, the network node may generate the association.

According to an embodiment, the network node 310 may configure the active device 320 for DL PTD signal reception but trigger the reception of the backscatter PTD signal for given instances, e.g. only for given instances. For example, the DL PTD signal 316, 318 may be sent with periodicity D1, but the active device 320 may be triggered to measure the backscatter PTD signal 324 with periodicity D2, which is larger than D1. Alternatively, the active device 320 may be triggered to measure the backscatter PTD signal 324 upon explicit request, e.g. only upon explicit request. The explicit request from the network node 310 may be comprised in a dedicated information element, e.g., over a DL physical dedicated control channel (PDCCH), which specifies the exact PTD occurrences. Configuring the measurements of the backscatter PTD signal upon explicit request is beneficial if the active device 320 is power limited or if the active device 320 performs other operations simultaneously, which are latency sensitive, for example, or if there is more than one active device 320 designated to detect at least one passive device 330. For example, the active devices may be scheduled using round-robin scheduling to perform the detection of the passive devices.

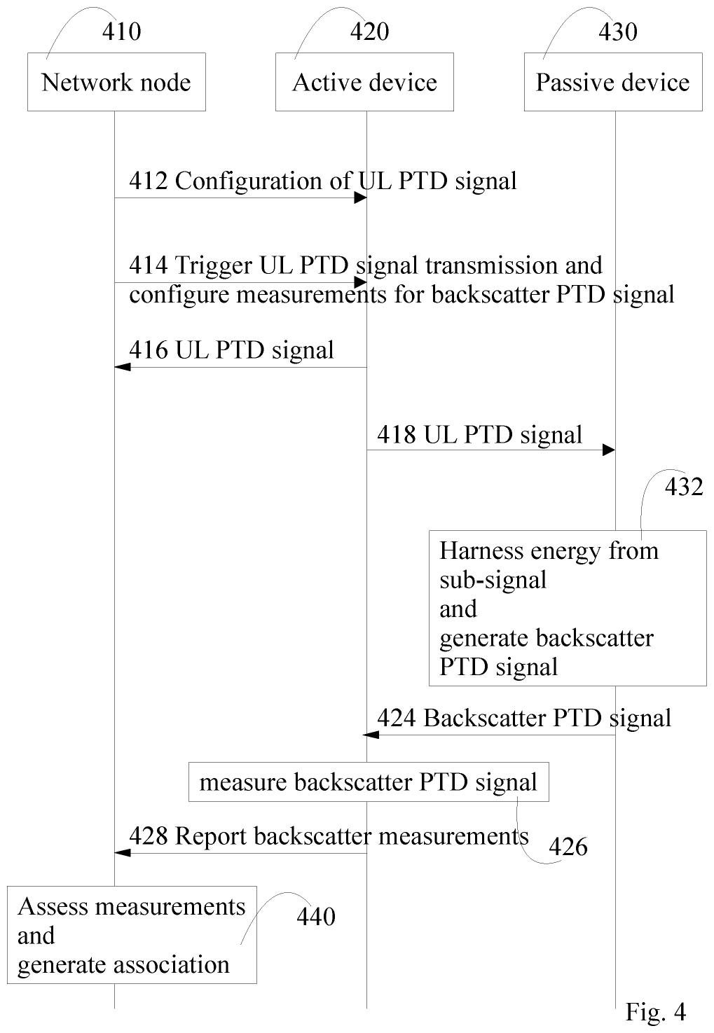

FIG. 4 shows, by way of example, signalling between entities. In this example, the UL PTD procedure is described. The network node 410, e.g. the serving gNB, transmits 412 a configuration of at least one PTD signal, e.g. PTD RS, associated with at least one passive device 430. The configuration provides the configuration of the PTD signal and implicitly the IDs of the passive devices. For example, the configuration may be specific to a pair of active device and a passive device.

The active device 420 receives, implicitly or explicitly, information for determining association between the at least one passive device and the at least one backscatter PTD signal. The association may be defined by a sub-signature associated with the at least one passive device, as described in the context of FIG. 2.

The network node 410 triggers 414 UL PTD signal transmission by an active device 420, e.g. a random UE, or a set of active devices randomly distributed in the cell, and configures measurements for the backscatter PTD signal 424 to be reflected by the at least one passive device 430. The configuration provides a configuration of the subsequent transmission of the UL PTD signals 416, 418. In addition, the network node 410 provides the configuration of the subsequent reception of the backscatter PTD signal. For example, the configuration comprises a duration T of detection, measurement types, etc. In other words, the network node 410 configures the active device 420 to transmit UL PTD signals 416, 418 for a duration T1 followed by a listening gap of duration T2 to hear a potential backscatter PTD signal 424 reflected by at least one passive device 430.

Time period T2 may be proportional to a total round trip time that a signal could take to travel a maximum distance D. Then, T2=2D/c, wherein c is the speed of the signal, which is approximately the speed of light in the Earth's atmosphere. For example, the maximum distance D may be dependent on the transmission power and noise level of the receiver that detects the signal.

The active device 420 transmits UL PTD signals 416, 418 to the network node 410 and at least one passive device 430.

The passive device 430 comprises an energy harvester. Thus, the passive device is capable of harvesting or harnessing energy from various sources, such as radio waves or signals, vibration and light. The passive device 430 harnesses 432 energy from the received PTD signal 318, or sub-signal, and generates a backscatter PTD signal, if the passive device determines that the PTD signal was intended for it. Determination may be based on the passive device specific sub-signature. The backscatter PTD signal 424 is generated by modifying, by the passive device 430, the received PTD signal and reflecting, by the passive device 430, the modified signal to be detected by the active device 420. The PDT signal may be modified by altering its amplitude, phase and/or center frequency, for example.

During the following time period T2, the active device 420 listens and attempts to detect at least one backscatter PTD signal from at least one passive device 430. The active device attempts to detect those backscatter PTD signals whose pattern matches the corresponding sub-signatures of the original UL PTD signal 418 generated and transmitted by the active device.

The active device 420 detects at least one backscatter PTD signal 424, and measures 426 detected backscatter PTD signal(s). The measurements of the backscatter PTD signal may comprise, for example, received signal strength indicator (RSSI), reference signal received power (RSRP), or any link quality metric.

The active device 420 reports 428 at least the measured backscatter to the network node 410. The report 428 may comprise, for example, a PTD flag and the results of the measurements associated with the identities of the detected passive devices.

The network node 410 assesses 440 the reported measurements, and may determine, based on the measurements, whether to associate the at least one active device 420 with the at least one detected passive device 430. For example, the network node may receive measurement reports from multiple active devices. The network node may be configured to compare the measurements, and select the active device, which reported the highest signal quality, for example, the highest received (RX) power. In other words, the active device, which has reported measurement results indicating that the active device hears the passive device the loudest, may be paired or associated with the passive device. If the network node receives measurement report from one active device, the network node may determine whether the reported measurement results satisfy some pre-determined threshold. If the measurement results do satisfy the threshold, the network node may generate association between the active device and the passive device. For example, if the RX power reported by the active device is higher than a pre-determined threshold, the network node may generate the association.

FIG. 5 shows, by way of example, signalling between entities. The network node 510 may interleave the DL PTD procedure, as described in the context of FIG. 3, and UL PTD procedure, as described in the context of FIG. 4. For example, the network node 510 may first configure the active device 520 for the DL PTD procedure 540. The active device 520 may perform the DL PTD procedure according to the configuration, as described in the context of FIG. 3.

The network node 510 may assess 542 the measurements reported by the active device 520. If the association between the active device 520 and a passive device 530 fails, the network node 510 may trigger 544 the UL PTD procedure. For example, the association may fail if none of the active devices has detected the passive device signal, or if the reported RX power levels are below a pre-determined threshold.

The active device 520 may perform the UL PTD procedure 546 according to the configuration from the network node 510, as described in the context of FIG. 4.

If the DL PTD procedure has failed due to not detecting any passive devices, the measurements of the UL PTD procedure may be assessed without taking into account the DL PTD procedure. If the reported RS power levels were too low in the DL PTD procedure, the network node 510 may then combine 548 the measurements reported along with the DL PTD procedure and the UL PTD procedure. The network node 510 may assess measurements from both procedures and determine whether to generate association between the active device 520 and the at least one passive device 530.

The network node 510 may be configured to compare the measurements reported by the active devices and decide, based on the comparison, whether to generate 550 the association. For example, the network node may compare the RX power levels reported by the active devices.

In the example of FIG. 5, the DL PTD procedure 540 is performed first and the UL PTD procedure 546 after a failed association resulting from the DL PTD procedure. According to an embodiment, the UL PTD procedure may be performed first. If the association after the UL PTD procedure fails, the network node 510 may trigger the DL PTD procedure.

FIG. 6 shows, by way of example, signalling between entities. Network node 610 may configure the active device 620 to perform 640 the DL PTD procedure, as described in the context of FIG. 3, or the UL PTD procedure, as described in the context of FIG. 4, or both procedures as described in the context of FIG. 5.

The network node 610 may assess 642 measurements from the DL PTD procedure or UL PTD procedure or both procedures.

The network node 610 may generate 644 association between at least one active device 620 and at least one passive device 630.

The network node 610 may transmit 646 information on the association between at least one active device 620 and at least one passive device 630 to a location management function (LMF) 600 for positioning of the at least one passive device. For example, the information on the association may comprise a list of ‘active device-passive device’ pairs, e.g. ‘UE-passive IoT ID’ pairs. The LMF 600 may trigger the passive device positioning 648 session. The LMF 600 may use the outcome of the PTD procedure(s) between the network node 610, at least one active device 620 and at least one passive device 630 for configuring the positioning session 648. The outcome of the PTD procedure(s) is the association between the active devices and the passive devices.

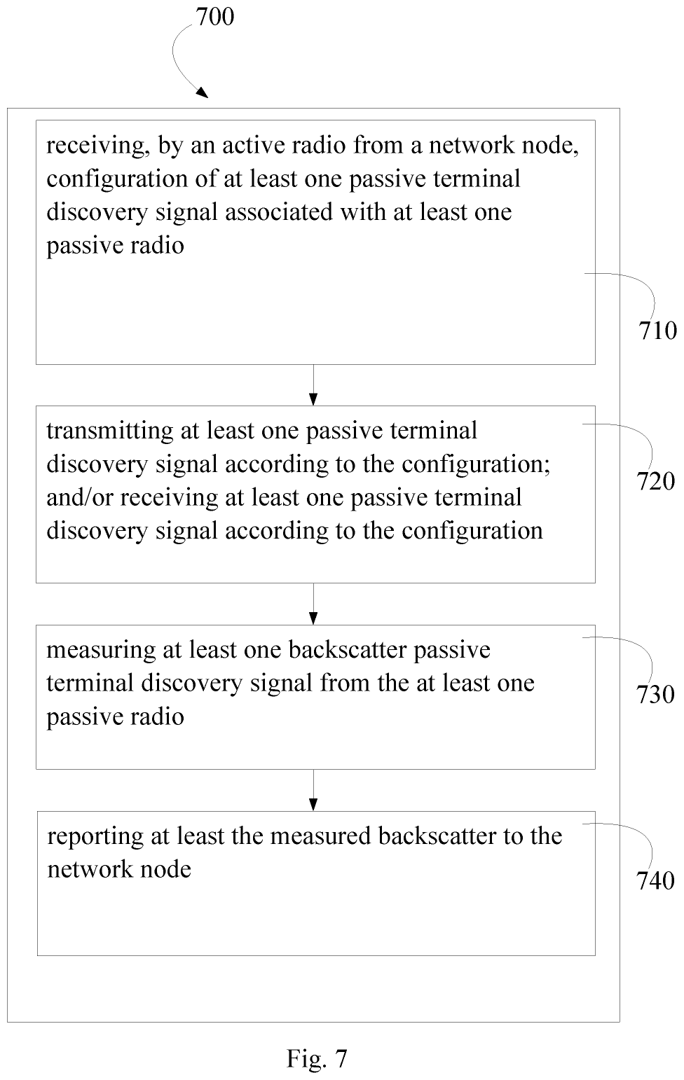

FIG. 7 shows, by way of example, a flowchart of a method 700. The phases of the method 700 may be performed by an active device or an active radio or an active radio device, e.g. an UE, RSU or a small gNB, or by a control device configured to control the functioning thereof, when installed therein. The active device may be, for example, the active device 320, 420, 520, 620 of FIG. 3, FIG. 4, FIG. 5 or FIG. 6, respectively, which is configured to perform at least the method 700. The method 700 comprises receiving 710, by an active radio from a network node, configuration of at least one passive terminal discovery signal associated with at least one passive radio. The method 700 comprises transmitting 720 at least one passive terminal discovery signal according to the configuration; and/or receiving at least one passive terminal discovery signal according to the configuration. The method 700 comprises measuring 730 at least one backscatter passive terminal discovery signal from the at least one passive radio. The method 700 comprises reporting 740 at least the measured backscatter to the network node.

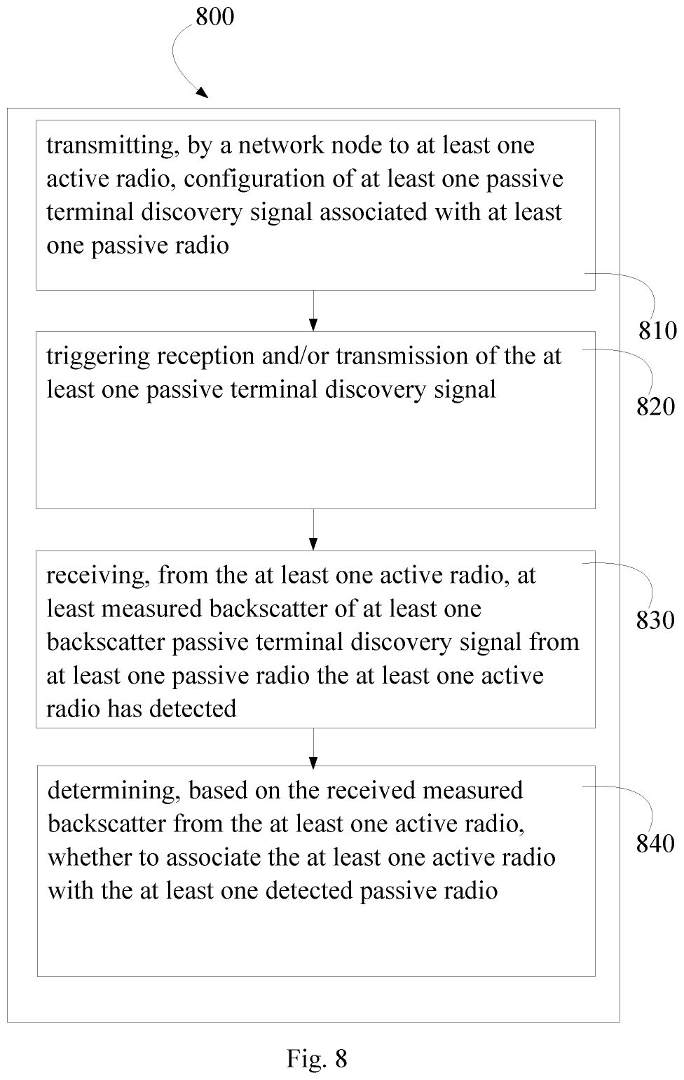

FIG. 8 shows, by way of example, a flowchart of a method 800. The phases of the method 800 may be performed by a network node, e.g. a gNB, or by a control device configured to control the functioning thereof, when installed therein. The network node may be, for example, the network node 310, 410, 510, 610 of FIG. 3, FIG. 4, FIG. 5 or FIG. 6, respectively, which is configured to perform at least the method 800. The method 800 comprises transmitting 810, by a network node to at least one active radio, configuration of at least one passive terminal discovery signal associated with at least one passive radio. The method 800 comprises triggering 820 reception and/or transmission of the at least one passive terminal discovery signal. The method 800 comprises receiving 830, from the at least one active radio, at least measured backscatter of at least one backscatter passive terminal discovery signal from at least one passive radio the at least one active radio has detected. The method 800 comprises determining 840, based on the received measured backscatter from the at least one active radio, whether to associate the at least one active radio with the at least one detected passive radio.

Methods as disclosed herein enable data transfer from the passive device to the network node. Methods as disclosed herein enable localization of passive devices by using an optimum set of active devices. The optimum set of active devices comprises at least one active device which has been associated, by the network node, with at least one passive device based on measured backscatter passive terminal discovery signal reflected by the at least one passive device. PTD signal has a double purpose of serving as a reference signal, e.g. for transmitting CSI or as a positioning reference signal (PRS), and including a sub-signature associated with a passive device such that an active device is able to detect the passive device, which backscatters the PTD signal.

The DL PTD signal has a first purpose regarding an active device and a second purpose regarding a passive device. The first purpose comprises, for example, at least one of: paging, synchronization, initial access, demodulation purpose, and positioning. For the purpose of paging, the reference signal is a paging signal. For the purpose of synchronization, the reference signal is a synchronization signal. For the purpose of initial access, the reference signal is a physical random access channel (PRACH) signal. For the purpose of demodulation, the reference signal is a downlink demodulation reference signal (DL DMRS). For the purpose of positioning, the reference signal is a downlink positioning reference signal (DL PRS).

The UL PTD signal has a first purpose regarding an active device and a second purpose regarding a passive device. The first purpose comprises, for example, at least one of: uplink channel determination, demodulation, and positioning. For the purpose of uplink channel determination, the reference signal is a sounding reference signal (SRS). For the purpose of demodulation, the reference signal is a downlink demodulation reference signal (DMRS). For the purpose of positioning, the reference signal is SRS for positioning.

The second purpose is the same for the DL PTD signal and the UL PTD signal. The second purpose regarding a passive device comprises including a sub-signature associated with a passive device such that an active device is able to detect the passive device, which backscatters the PTD signal.

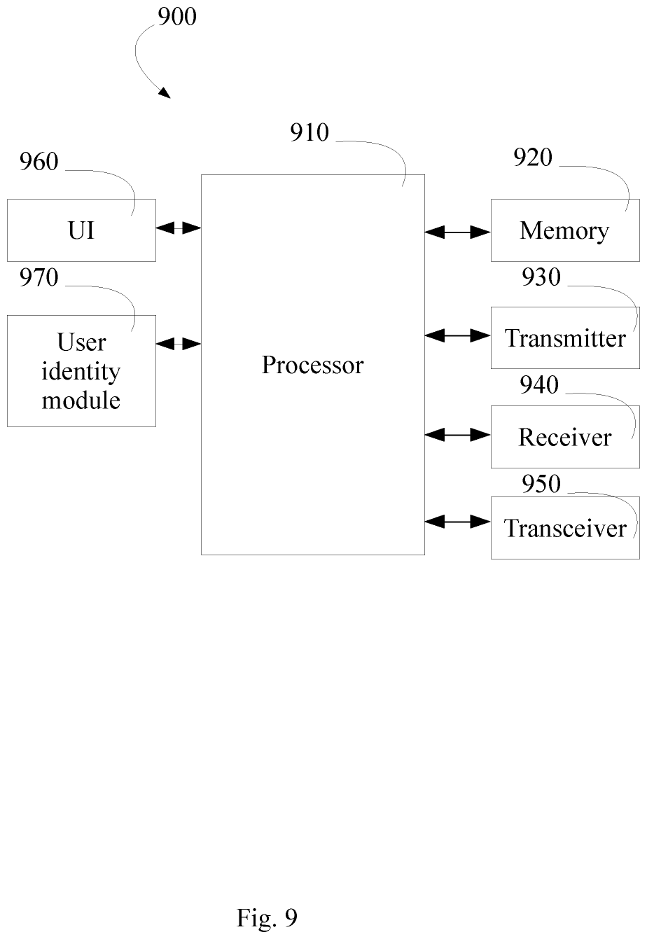

FIG. 9 shows, by way of example, a block diagram of an apparatus capable of performing at least the method(s) as disclosed herein. Illustrated is device 900, which may comprise, for example, a mobile communication device such as an active device, e.g. the active device 320, 420, 520, 620 of FIG. 3, FIG. 4, FIG. 5 or FIG. 6, respectively. Alternatively, the device 900 may comprise a network node, e.g. the network node 310, 410, 510, 610 of FIG. 3, FIG. 4, FIG. 5 or FIG. 6, respectively. Comprised in device 900 is processor 910, which may comprise, for example, a single-or multi-core processor wherein a single-core processor comprises one processing core and a multi-core processor comprises more than one processing core. Processor 910 may comprise, in general, a control device. Processor 910 may comprise more than one processor. Processor 910 may be a control device. A processing core may comprise, for example, a Cortex-A8 processing core manufactured by ARM Holdings or a Steamroller processing core designed by Advanced Micro Devices Corporation. Processor 910 may comprise at least one Qualcomm Snapdragon and/or Intel Atom processor. Processor 910 may comprise at least one application-specific integrated circuit, ASIC. Processor 910 may comprise at least one field-programmable gate array, FPGA. Processor 910 may be means for performing method steps in device 900. Processor 910 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as an active device, e.g., a user equipment, or a network node, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 900 may comprise memory 920. Memory 920 may comprise random-access memory and/or permanent memory. Memory 920 may comprise at least one RAM chip. Memory 920 may comprise solid-state, magnetic, optical and/or holographic memory, for example. Memory 920 may be at least in part accessible to processor 910. Memory 920 may be at least in part comprised in processor 910. Memory 920 may be means for storing information. Memory 920 may comprise computer instructions that processor 910 is configured to execute. When computer instructions configured to cause processor 910 to perform certain actions are stored in memory 920, and device 900 overall is configured to run under the direction of processor 910 using computer instructions from memory 920, processor 910 and/or its at least one processing core may be considered to be configured to perform said certain actions. Memory 920 may be at least in part external to device 900 but accessible to device 900.

Device 900 may comprise a transmitter 930. Device 900 may comprise a receiver 940. Transmitter 930 and receiver 940 may be configured to transmit and receive, respectively, information in accordance with at least one cellular or non-cellular standard. Transmitter 930 may comprise more than one transmitter. Receiver 940 may comprise more than one receiver. Transmitter 930 and/or receiver 940 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 900 may comprise a near-field communication, NFC, transceiver 950. NFC transceiver 950 may support at least one NFC technology, such as NFC, Bluetooth, Wibree or similar technologies.

Device 900 may comprise user interface, UI, 960. UI 960 may comprise at least one of a display, a keyboard, a touchscreen, a vibrator arranged to signal to a user by causing device 900 to vibrate, a speaker and a microphone. A user may be able to operate device 900 via UI 960, for example to accept incoming telephone calls, to originate telephone calls or video calls, to browse the Internet, to manage digital files stored in memory 920 or on a cloud accessible via transmitter 930 and receiver 940, or via NFC transceiver 950, and/or to play games.

Device 900 may comprise or be arranged to accept a user identity module 970. User identity module 970 may comprise, for example, a subscriber identity module, SIM, card installable in device 900. A user identity module 970 may comprise information identifying a subscription of a user of device 900. A user identity module 970 may comprise cryptographic information usable to verify the identity of a user of device 900 and/or to facilitate encryption of communicated information and billing of the user of device 900 for communication effected via device 900.

Processor 910 may be furnished with a transmitter arranged to output information from processor 910, via electrical leads internal to device 300, to other devices comprised in device 900. Such a transmitter may comprise a serial bus transmitter arranged to, for example, output information via at least one electrical lead to memory 920 for storage therein. Alternatively to a serial bus, the transmitter may comprise a parallel bus transmitter. Likewise processor 910 may comprise a receiver arranged to receive information in processor 910, via electrical leads internal to device 900, from other devices comprised in device 900. Such a receiver may comprise a serial bus receiver arranged to, for example, receive information via at least one electrical lead from receiver 940 for processing in processor 910. Alternatively to a serial bus, the receiver may comprise a parallel bus receiver.

Processor 910, memory 920, transmitter 930, receiver 940, NFC transceiver 950, UI 960 and/or user identity module 970 may be interconnected by electrical leads internal to device 900 in a multitude of different ways. For example, each of the aforementioned devices may be separately connected to a master bus internal to device 900, to allow for the devices to exchange information. However, as the skilled person will appreciate, this is only one example and depending on the embodiment various ways of interconnecting at least two of the aforementioned devices may be selected.

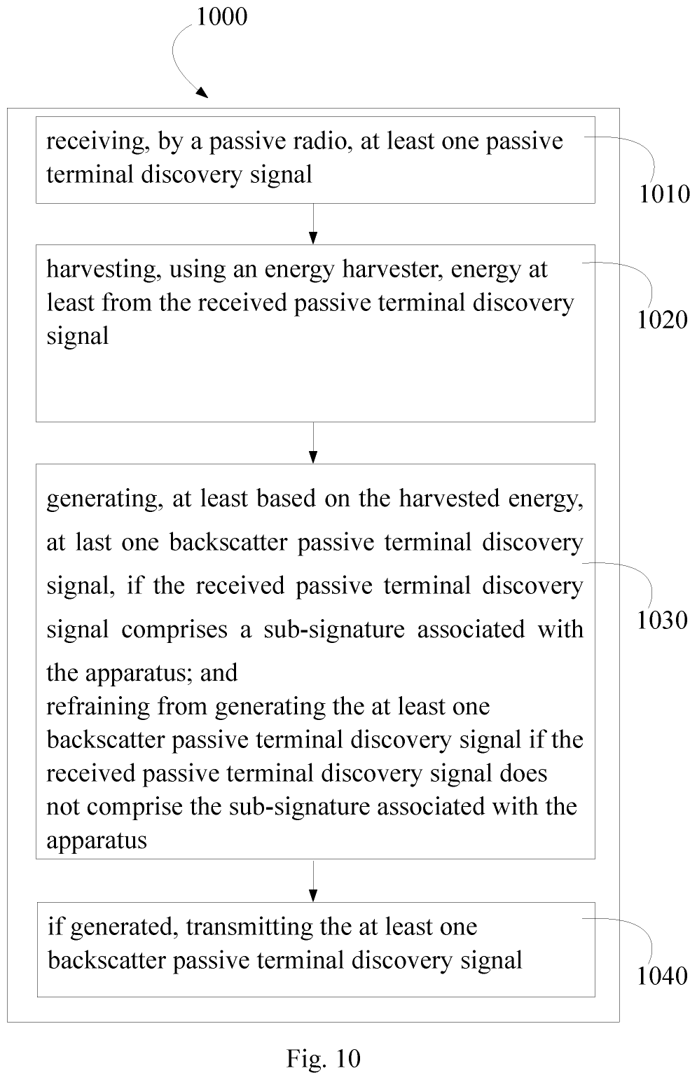

FIG. 10 shows, by way of example, a flowchart of a method 1000. The phases of the method 1000 may be performed by a passive radio or passive device, e.g. a tag. The passive device may be, for example, the passive device 330, 430, 530, 630 of FIG. 3, FIG. 4, FIG. 5 or FIG. 6, respectively, which is configured to perform at least the method 1000. The method 1000 comprises receiving 1010, by a passive radio, at least one passive terminal discovery signal. The method comprises harvesting 1020, using an energy harvester, energy at least from the received passive terminal discovery signal. The method 1000 comprises generating 1030, at least based on the harvested energy, at least one backscatter passive terminal discovery signal, if the received passive terminal discovery signal comprises a sub-signature associated with the apparatus; and refraining from generating the at least one backscatter passive terminal discovery signal if the received passive terminal discovery signal does not comprise the sub-signature associated with the apparatus. The method 1000 comprises: if generated, transmitting 1040 the at least one backscatter passive terminal discovery signal.

1. An apparatus comprising at least one processor; and at least one memory including computer program code, the at least one memory and the computer program code configured to, with the at least one processor, cause the apparatus to perform at least:
receiving, from a network node, configuration of at least one passive terminal discovery signal associated with at least one passive radio;
transmitting at least one passive terminal discovery signal according to the configuration; and/or receiving at least one passive terminal discovery signal according to the configuration;
measuring at least one backscatter passive terminal discovery signal from the at least one passive radio; and
reporting at least the measured backscatter to the network node.

2. The apparatus of claim 1, caused to perform:
receiving information for determining association between the at least one passive radio and the at least one backscatter passive terminal discovery signal.

3. The apparatus of claim 2, wherein the association is defined by a sub-signature associated with the at least one passive radio, wherein the sub-signature is passive radio specific configuration of a subset of radio resources.

4. The apparatus of claim 1, wherein the configuration of at least one passive terminal discovery signal comprises: a configuration for transmission of at least one passive terminal discovery signal.

5. The apparatus of claim 4, caused to perform:
detecting at least one backscatter passive terminal discovery signal from the at least one passive radio based on a pattern of the signal corresponding to a sub-signature associated with the transmitted at least one passive terminal discovery signal.

6. The apparatus of claim 1, wherein the configuration of at least one passive terminal discovery signal comprises: a configuration for reception of at least one passive terminal discovery signal.

7. The apparatus of claim 6, caused to perform:
measuring, according to the configuration, the at least one passive terminal discovery signal received from the network node, wherein the at least one passive terminal discovery signal is a double purpose signal having a first purpose regarding the apparatus and a second purpose regarding the passive radio; and
transmitting measurement results to the network node.

8. The apparatus of claim 7, wherein the first purpose comprises at least one of: paging, synchronization, initial access, demodulation, and positioning.

9. The apparatus of claim 3,
wherein the sub-signature is based on at least one of: time dimension, frequency dimension, or waveform of the passive terminal discovery signal.

10. The apparatus of any claim 3,
wherein the sub-signature is unique for a passive radio.

11. The apparatus of claim 3,
wherein the sub-signature is unique for a group of passive radios.

12. The apparatus of claim 1, caused to perform:
receiving a request to measure the at least one backscatter passive terminal discovery signal.

13. The apparatus of claim 1, caused to perform:
transmitting the at least one passive terminal discovery signal according to the configuration, wherein the at least one passive terminal discovery signal is a double purpose signal having a first purpose regarding the apparatus and a second purpose regarding the at least one passive radio.

14. The apparatus of claim 13, wherein the first purpose comprises at least one of: uplink channel determination, demodulation, and positioning.

15-23. (canceled)

24. A method, comprising:
receiving, by an active radio from a network node, configuration of at least one passive terminal discovery signal associated with at least one passive radio;
transmitting at least one passive terminal discovery signal according to the configuration; and/or receiving at least one passive terminal discovery signal according to the configuration;
measuring at least one backscatter passive terminal discovery signal from the at least one passive radio; and
reporting at least the measured backscatter to the network node.

25. The method of claim 24, comprising:
receiving information for determining association between the at least one passive radio and the at least one backscatter passive terminal discovery signal.

26-31. (canceled)

32. The method of claim 24,
wherein the sub-signature is based on at least one of: time dimension, frequency dimension, or waveform of the passive terminal discovery signal.

33-34. (canceled)

35. The method of claim 24, comprising:
receiving a request to measure the at least one backscatter passive terminal discovery signal.

36. The method of claim 24, comprising:
transmitting the at least one passive terminal discovery signal according to the configuration, wherein the at least one passive terminal discovery signal is a double purpose signal having a first purpose regarding the apparatus and a second purpose regarding the passive radio.

37-59. (canceled)

60. An apparatus comprising:
an energy harvester;
at least one processor; and at least one memory including computer program code, the at least one memory and the computer program code configured to, with the at least one processor, cause the apparatus to perform at least:
receiving at least one passive terminal discovery signal;
harvesting, using the energy harvester, energy at least from the received passive terminal discovery signal;
generating, at least based on the harvested energy, at least one backscatter passive terminal discovery signal, if the received passive terminal discovery signal comprises a sub-signature associated with the apparatus; and
refraining from generating the at least one backscatter passive terminal discovery signal if the received passive terminal discovery signal does not comprise the sub-signature associated with the apparatus; and
if generated, transmitting the at least one backscatter passive terminal discovery signal.

61-64. (canceled)
